(19) United States
(12) Patent Application Publication
(10) Pub. No.: US 2020/0032754 A1
(43) Pub. Date: Jan. 30, 2020

(54) ASSEMBLY FOR A COMBUSTION ENGINE

(71) Applicant: CONTINENTAL AUTOMOTIVE GMBH, Hannover, DE (US)

(72) Inventors: Giandomenico SERRA, Ghezzano - S.Giuliano Terme (PI) (IT); Andrea PUCCINI, San Miniato (PI) (IT); Stefano BARTOLINI, Chiesina Uzzanese (PT) (IT)

(73) Assignee: CONTINENTAL AUTOMOTIVE GMBH, Hannover (DE)

(21) Appl. No.: 15/736,412

(22) PCT Filed: May 25, 2016
(86) PCT No.: PCT/EP2016/061765

§ 371 Date: Dec. 14, 2017

(30) Foreign Application Priority Data
Jun. 22, 2015 (EP) 15173060.3

(51) Int. Cl. F02M 61/14

(52) U.S. Cl. CPC F02M 61/14

(57) ABSTRACT

An assembly (1) for a combustion engine is disclosed. It comprises a coupling element (5) with a penetrating opening (17), a retaining element (13), and a bolt (3). The bolt (3) extends through the penetrating opening (17) which is shaped by a circumferential surface (18) extending between a first axial end (7) and a second axial end (9) of the penetrating opening (17) through the coupling dement (5). A coupling between the retaining element (13) and the bolt (3) is established in a region subsequent to the first axial end (7) in direction from the second axial end (9) to the first axial end (7) and the retaining element (13) and the coupling element (5) interact mechanically to restrict an axial displacability of the retaining element (13) relative to the coupling element (5). The bolt (3) is locked with respect to axial displacement relative to the coupling element (5).

The invention relates to an assembly for mechanically retaining a bolt of a combustion engine.

Fuel injectors are in widespread use in particular for internal combustion engines where they may be arranged in order to dose a fuel into an intake manifold of the internal combustion engine or directly into a combustion chamber of a cylinder of the internal combustion engine.

Components of a combustion engine are fixed in their positions relative to each other, for example by using welding connections or bolts. For instance, this concerns a fuel rail assembly for a combustion engine wherein manufacturers require already inserted bolts in predetermined positions at a specified height in order to enable an easier and faster screwing-in process at engine plant site.

To accomplish these requirements one or more components are necessary to hold a bolt in its desired position during handling and transportation while the fuel rail assembly is assembled into the engine, for example. Hence, the mentioned components have to avoid undesired movement of the bolt. One common use is to insert a plastic retainer with a cylindrical shape into a given opening which for example surrounds a pre-assembled bolt and acts as a sleeve.

But such a plastic retainer needs to be configured with a minimum height and well-defined geometrical tolerances to work properly and retain a movement of the bolt. Thus, in dependency of a size of the bolt there are geometrical requirements concerning a wall of the opening and hence the corresponding component the opening belongs to. The bigger a diameter of the bolt is, the bigger is the minimum height of the wall of the opening and the corresponding component.

One object of the invention is to specify an assembly for mechanically retaining a bolt of a combustion engine which facilitates a reliable and precise functioning by means of reducing undesirable movement of the bolt and coupled components for a combustion engine.

The object is achieved by the features of the independent claim. Advantageous embodiments of the invention are given in the dependent claims.

An assembly for a combustion engine is specified. The combustion engine may expediently be an internal combustion engine. Preferably, the assembly is a fuel rail assembly. The fuel rail assembly is in particular provided for delivering fuel to a fuel injector of the combustion engine. Expediently, the fuel rail assembly comprises a fuel rail and an injector cup. The fuel rail is in particular an elongated fuel reservoir. The injector cup comprises an injector opening, i.e. in particular a recess, for receiving the fuel injector, in particular for receiving a fuel inlet end of the fuel injector. The fuel rail is fluidly connected to the injector opening.

The assembly comprises a coupling element with a penetrating opening, a retaining element, and a bolt. The penetrating opening has a longitudinal axis. The bolt extends through the penetrating opening of the coupling element, in particular in longitudinal direction.

The penetrating opening of the coupling element is shaped by a circumferential surface. The circumferential surface is in particular comprised by the coupling element. It extends through the coupling element between a first axial end and a second axial end of the penetrating opening with respect to the longitudinal axis. In particular the circumferential surface extends from the first axial end to the second axial end. The first axial end of the penetrating opening is in particular comprised by an upper surface of the coupling element. The second axial end is in particular comprised by a lower surface of the coupling element. The upper and the lower surface may expediently face in opposite axial directions. Preferably, the upper surface and the lower surface are connected by a side surface of the coupling element. The upper and the lower surface may preferably interface with the side surface. The side surface extends parallel to the longitudinal axis in one embodiment.

A coupling between the retaining element and the bolt is established in a region extending away from the first axial end and facing away from the second axial end of the penetrating opening of the coupling element such that an area between the circumferential surface and the bolt is free from the retaining element. To put it differently, the coupling is established in a region which is positioned subsequent to the first axial end in direction from the second axial end to the first axial end. The retaining element does in particular not extend into a radial gap between the circumferential surface and the bolt. In other words, the complete retaining element is arranged outside of the penetrating opening.

The retaining element and the coupling element interact mechanically to restrict an axial displacability of the retaining element relative to the coupling element so that the bolt is locked with respect to axial displacement relative to the coupling element by the mechanical interaction of the retaining element and the coupling element and by the coupling between the retaining element and the bolt.

In this way, mechanically retaining a bolt of a combustion engine is particularly simple and reliable. The interaction of the retaining element and the coupling element enables fixation of the bolt and counteracts an undesirable movement of the bolt. Hence, it makes a contribution to a reliable positioning of the bolt, for example in a pre-assembled condition and/or during transport of the assembly, and further enables a secure coupling of the coupling element to a cylinder head, if applicable.

With advantage, the assembly may enable coupling of components for a combustion engine without a necessity for special dimensioning. For example there is no need for a given thickness of the coupling element in order to have a sufficient length as it is required if a plastic retainer is inserted into the penetrating opening of the coupling element to enable a desired elastic force or friction force to retain the bolt. Further, there is no need for tight geometrical tolerances because the retaining element does not have to fit in the penetrating opening of the coupling element.

The retaining element acts externally against an undesired axial movement of the bolt and may match a shape of the coupling element partially, for example. Hence, a shape of the coupling element can be simplified and kept small just to fulfil structural requirements which enables a reduction of mass and costs of the assembly.

Thus, by use of the retaining element a stability of the assembly may be enhanced and an uncontrolled movement of the bolt and coupled components is attenuated. During handling and transportation and operation of the assembly or of a combustion engine comprising the assembly, the position of the bolt is secured and this contributes to an improved manufacturing process and a reliable and secure functioning of the assembly.

In one embodiment, the coupling element comprises a stopping element and the retaining element comprises a shoring element which are configured to restrict an axial movement of the stopping element and retain an axial movement of the bolt relative to the coupling element with respect to the longitudinal axis in a direction from the second axial end to the first axial end by a mechanical interaction of the retaining element and the coupling element. To put it differently, the stopping element and the shoring element interact mechanically to restrict the axial displacability of the retaining element relative to the coupling element. Preferably, the stopping element and the shoring element interact mechanically by means of a form-fit engagement between the stopping element and the shoring element.

According to a further embodiment the retaining element comprises a penetrating opening through which the bolt extends. In particular, the bolt extends through the penetrating opening of the retaining element to limit lateral displacability of the retaining element relative to the coupling element. For example, the lateral displacability is limited by form-fit engagement of the bolt with the circumferential surface of the penetrating opening of the coupling element and with a circumferential sidewall of the penetrating opening of the retaining element.

In this way, advantageous coupling of the retaining element, the coupling element, and the bolt is simply and reliably achievable. The retaining element may be coupled loosely to the coupling element and gets fastened for transport of the assembly and for installation into the engine by the bolt assembled through the penetrating opening of the retaining element and through the penetrating opening of the coupling element—before the bolt is inserted into an opening of a cylinder head.

For example, the penetrating opening of the retaining element is configured to match the diameter of the bolt to enable retention of the position of the bolt after assembling. The retaining element may be made of bended sheet metal. It may exhibit a slightly flexible behavior to enable a simple arrangement of the bolt, for example. The retaining element may further be configured to be slightly rotatable and/or moveable in order not to obstruct or impose any radial constraint to a bolt assembling process and coupled components.

According to a further embodiment, a circumferential sidewall of the penetrating opening of the retaining element comprises one or more fixing protrusions. The fixation protrusions extend in particular in radial inward direction. Preferably, they are in friction-fit engagement with the bolt to establish the coupling between the retaining element and the bolt.

By mean of the protrusion(s), a reliable and simple retention of the bolt is achievable. In a mounted configuration of the assembly—for example when the assembly is fixed to the cylinder head of the engine—the bolt may be screwed into the opening of the cylinder head through the penetrating opening of the retaining element and through the penetrating opening of the coupling element. An outer surface of the bolt preferably contacts the one or more protrusions and in particular slightly deforms the protrusion(s) for establishing the friction-fit.

In one development, the protrusions are realized as fixing pins with pinnacles facing the outer surface of the assembled bolt. In another development, the protrusions comprise a half spherical shape which contacts the outer surface of the bolt when the bolt extends through the penetrating opening of the retaining element.

Hence, the retaining element comprising protrusions realizes an advantageous embodiment of the assembly to counteract an undesirable movement of the bolt. In this context, a number, a shape, a dimensioning and a material of the protrusions are determining the axial retention force applied on the bolt and can vary depending on requirements and application.

According to one embodiment, the coupling element comprises a first recess extending away from the first axial end and facing away from the second axial end of the penetrating opening of the coupling element and a second recess extending away from the second axial end and facing away from the first axial end of the penetrating opening of the coupling element. The shoring element of the retaining element is arranged in the second recess of the coupling element. To put it differently, the coupling element comprises a first recess and a second recess on opposite sides of the penetrating opening. The penetrating opening extends from a bottom surface of the first recess to a bottom surface of the second recess. In particular, the bottom surface of the first recess comprises the first axial end of the penetrating opening of the coupling element and the bottom surface of the second recess comprises the second axial end of the penetrating opening of the coupling element. The shoring element which is arranged in the second recess is in particular in form-fit engagement with the bottom surface of the second recess.

In this way, particularly good mechanical interaction between the retaining element and the coupling element is achievable. For example, the retaining element comprises a shape of clamp and acts as an external snapping bolt retainer. Due to the shoring element that is arranged in the second recess of the coupling element an elastic counteracting force may be generated by the retaining element if an axial movement of the bolt in direction from the second axial end to the first axial end occurs. The elastic force generated by the preferably resilient retaining element may increase when a mechanical force of the bolt generated by an undesirable axial movement increases. In addition, the retaining element which is at least partially positioned in the recesses of the coupling element, with advantage, makes no or only a little contribution to the size of the assembly.

According to a further embodiment the retaining element comprises a first section, a second section adjacent to the first section and a third section adjacent to the second section. In particular, the first and third sections adjoin the second section on opposite sides. The first section comprises the shoring element and is positioned at a distance from and substantially parallel to the third section. The second section is substantially perpendicular to the first section and the third section, respectively. The three sections are in particular configured to match respective contours of the coupling element. In one development, the third section of the retaining element comprises the penetrating opening of the retaining element.

In this context, the expressions “substantially parallel” and “substantially perpendicular” are understood to mean that the main planes of extension of the respective sections are parallel or perpendicular, respectively, notwithstanding possible typical tolerances of 5° or less, in particular of 2° or less.

Such a shape may be advantageous for the retaining element to act as a clamp or an external snapping bolt retainer. Hence, the retaining element may substantially match a shape of an ashlar-formed coupling element and may comprise a spring-like behaviour to counteract an undesired axial movement of the bolt. For example, the first section of the assembled retaining element is coupled to the lower surface, the second section to the side surface and the third section the upper surface of the coupling element. The lower and upper surfaces in particular comprise the bottom surfaces of the second and first recess, respectively.

According to a further embodiment, the retaining element further comprises a fourth section adjacent to the third section and a fifth section adjacent to the fourth section. The fifth section is positioned at a distance from and substantially parallel to the third section and the fourth section is substantially perpendicular to the third and fifth section respectively. Preferably, all sections are shaped and arranged to match respective contours of the coupling element.

In this way, the retaining element may advantageously be realized as a two side clamp. In particular, the fourth section of the assembled retaining element is coupled to another side surface at a side of the coupling element opposite of the second section, for example. Further, the fifth section is preferably coupled to the bottom surface of the coupling element as well as the first section.

According to a further embodiment, the injector cup comprises the coupling element. This embodiment describes one beneficial use of the assembly for mechanically retaining the bolt which further fastens the injector cup to a cylinder head, for example.

According to a further embodiment, the coupling element is comprised by or directly attached to the injector cup, for example by a brazed and/or welded connection. For example, the injector cup comprises a bracket which represents the coupling element. The bracket is in particular comprised by a flange of the injector cup which laterally surrounds the injector opening. This configuration is one practical realization of the coupling element wherein the bolt fastens the injector cup to the cylinder head. The retaining element is then coupled to the bracket which comprises the penetrating opening of the coupling element for arrangement of the bolt.

According to a further embodiment the assembly further comprises a separate connecting pipe which is arranged between the fuel rail and the injector cup and fluidly connects the fuel rail to the injector opening for providing fuel to the fuel injector. Preferably, the coupling element is comprised by or directly attached to the connecting pipe, for example by a brazed and/or welded connection.

This embodiment indicates another possibility for arrangement of the coupling element and the retaining element. Depending of the architecture the coupling element may be formed as one part of the connecting pipe and retention of an axial movement of the bolt is further realized by the retaining element coupled to the connecting pipe.

According to a further embodiment, the coupling element is comprised by or directly attached to the fuel rail, for example by a brazed and/or welded connection.

Exemplary embodiments of the invention are explained in the following with the aid of schematic drawings and reference numbers. Identical reference numbers designate elements or component with identical functions. The figures show:

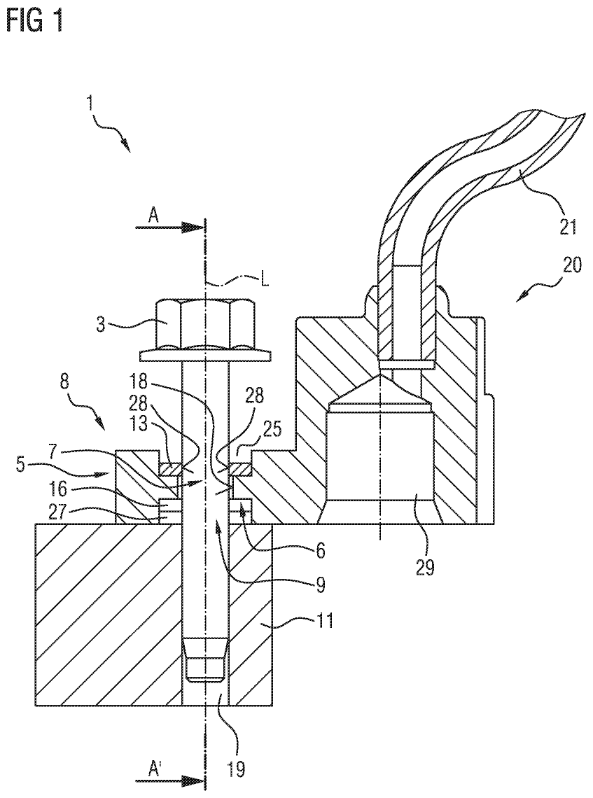

FIG. 1 a longitudinal section view of a portion of a fuel rail assembly according to a first exemplary embodiment;

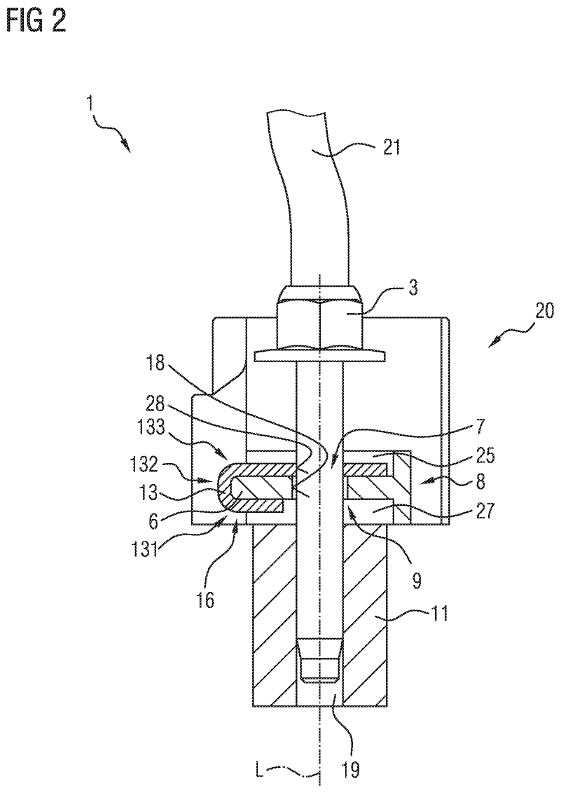

FIG. 2 another longitudinal section view of a portion of the fuel rail assembly according to the first exemplary embodiment;

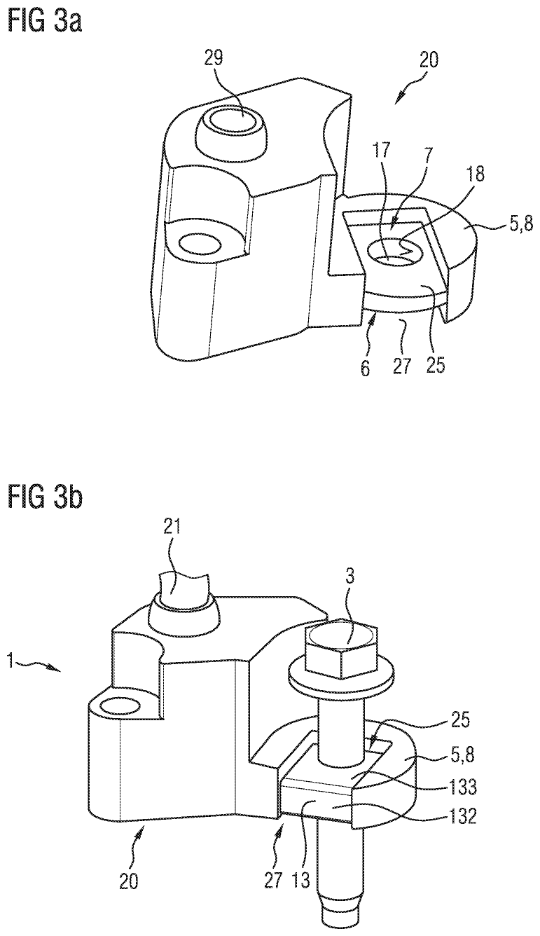

FIG. 3a a perspective view of an injector cup of the fuel rail assembly according to the first exemplary embodiment;

FIG. 3b a perspective view of a portion of the fuel rail assembly according to the first exemplary embodiment

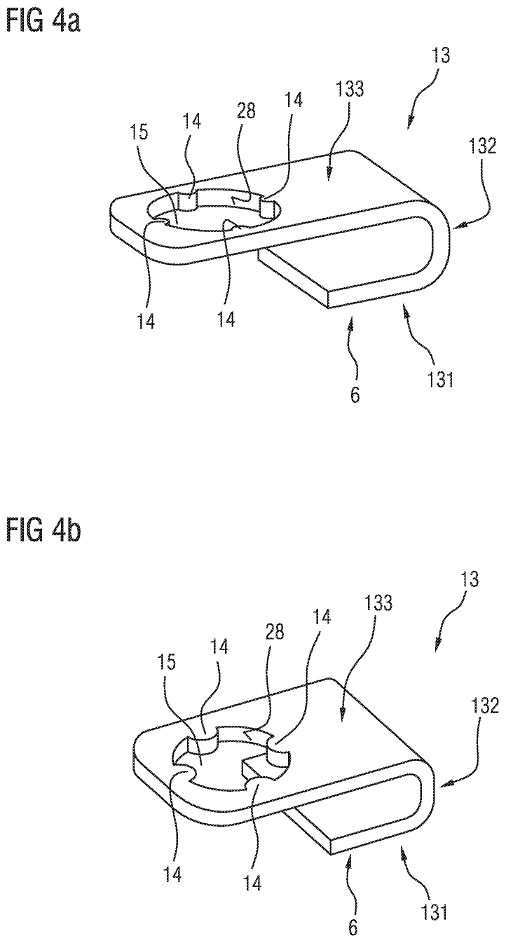

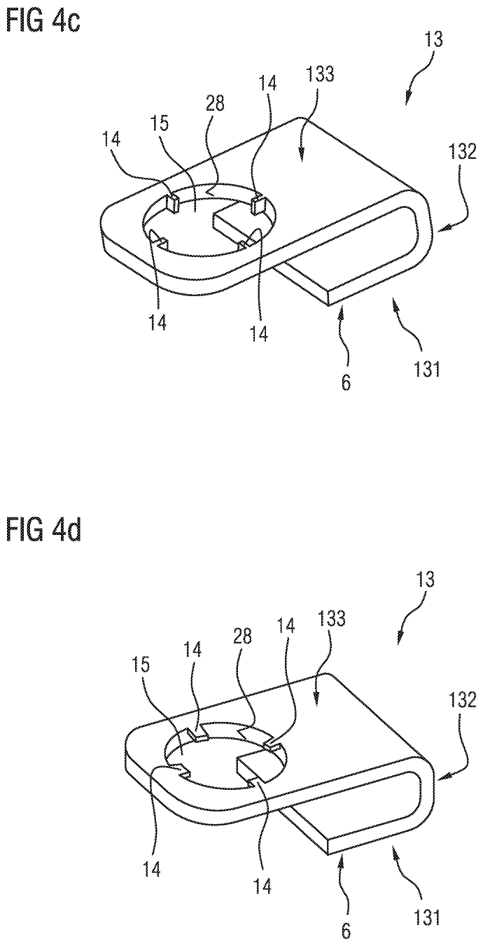

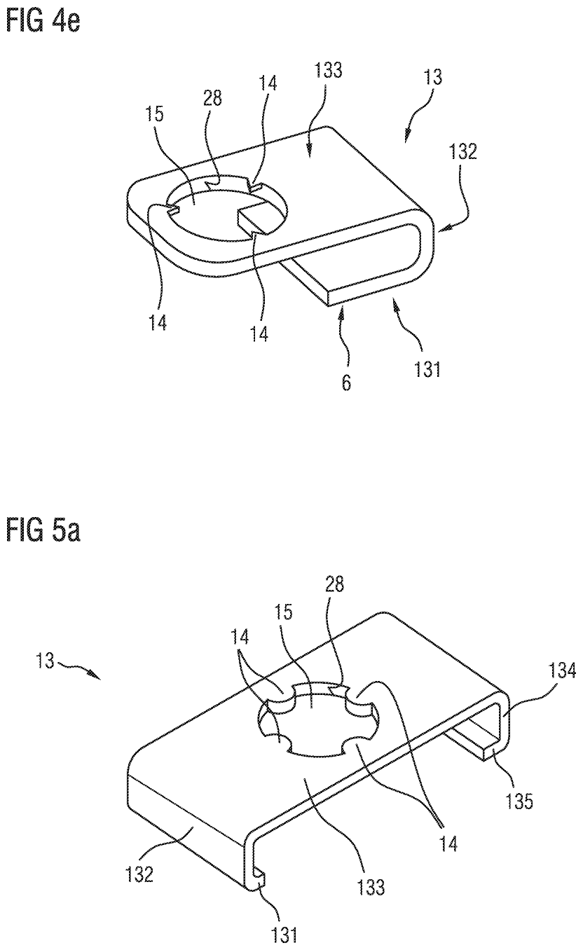

FIGS. 4a-4e perspective views of exemplary embodiments of retaining elements;

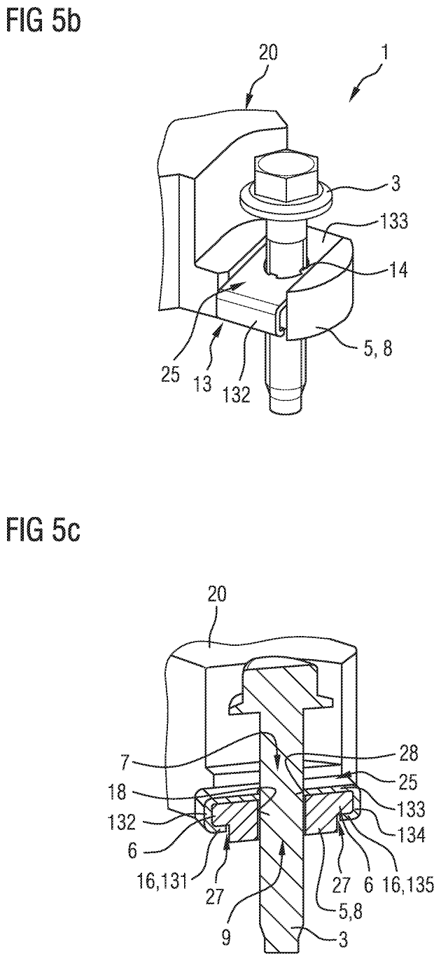

FIG. 5a a perspective view of a retaining element of a fuel rail assembly according to a second exemplary embodiment;

FIG. 5b a perspective view of a portion of the fuel rail assembly according to the second exemplary embodiment; and

FIG. 5c a longitudinally cut perspective view of a portion of the fuel rail assembly according to the second exemplary embodiment.

FIG. 1 shows a longitudinal section view of a portion of an assembly 1 for mechanically retaining a bolt 3 of a combustion engine. In the present embodiment, the assembly 1 is a fuel rail assembly. A further longitudinal section view—in the plane A-A′ indicated in FIG. 1—of a portion of the assembly 1 is shown in FIG. 2. FIG. 3b shows a perspective view of a portion of the assembly 1.

The assembly 1 comprises the bolt 3, a coupling element 5, and a retaining element 13. By means of the bolt 3, the coupling element 5 is attached to a cylinder head 11 of the combustion engine.

The coupling element 5 comprises a penetrating opening 17 has a longitudinal axis L and is defined by a circumferential surface 18 which extends around the longitudinal axis L. The bolt 3 extends through the penetrating opening 17 of the coupling element 5 and into an opening 19 of the cylinder head 11 to fasten the coupling element 5 to the cylinder head 11. For example, the bolt 3 and the opening 19 of the cylinder head 11 are threaded so that a screwed connection is established between the bolt 3 and the cylinder head 11.

The penetrating opening 17 of the coupling element 5 is formed by the circumferential surface 18 which extends between a first axial end 7 and a second axial end 9 of the penetrating opening 17 with respect to the longitudinal axis L. A coupling between the retaining element 13 and the bolt 3 is established in a region subsequent to the first axial end 7 and on the side of the first axial end 7 opposite of the second axial end 9 of the penetrating opening 17. Thus, an area between the circumferential surface 18 and the bolt 3 is free from the retaining element 13.

Furthermore, the coupling element 5 comprises a stopping element 6 and the retaining element 13 comprises a shoring element 16 which interact mechanically to restrict an axial displacement of the retaining element 13 relative to the stopping element 6. In this way, axial displacement of the bolt 3 relative to the coupling element 5 is prevented or limited with respect to the longitudinal axis L by the mechanical interaction of the retaining element 13 and the coupling element 5 and by the coupling between the retaining element 13 and the bolt 3.

In the present embodiment, the coupling element 5 is realized as a bracket 8 of a flange of an injector cup 20 for a fuel injector (not shown) of the combustion engine. The bolt 3 fastens the injector cup 20 via the bracket 8 to the cylinder head 11. The injector cup 20 has a recess, here denoted as injector opening 29, for receiving a fuel inlet end of the fuel injector. The injector opening 29 is fluidly connected to a fuel rail (not shown) of the assembly 1 by means of a connecting pipe 21 for providing fuel to the fuel injector of the combustion engine.

FIG. 3a shows a perspective view of the injector cup 20 with the bracket 8. The bracket 8—representing the coupling element 5—comprises a first recess 25 extending away from the first axial end 7 and facing away from the second axial end 9 of the penetrating opening 17 and a second recess 27 extending away from the second axial end 9 and facing away from the first axial end 7 of the penetrating opening 17 of the bracket 8. In the present embodiment, the bracket 8 comprises a disc shape with rectangular recesses 25 and 27.

The shoring element 16 of the retaining element 13 is mechanically coupled to the second recess 27 of the bracket 8 and may slightly contact a bottom surface of the bracket 8 and thus the stopping element 6. In the present embodiment, the stopping element 6 is an integral portion of the coupling element 5 and comprises a bottom surface of the second recess 27 which is a portion of the bottom surface of the bracket 8 and comprises the second axial end 9 of the penetrating opening 17 of the coupling element 5. The shoring element 16 is in particular in form-fit connection with the bottom surface of the second recess 27.

In the present exemplary embodiment, the retaining element 13 is in the shape of a clamp and acts as an external snapping bolt retainer. The retaining element 13 comprises a first section 131, a second section 132 adjacent to the first section 131 and a third section 133 adjacent to the second section 132 on a side of the second section 132 remote from the first section 131 (see e.g. FIG. 2). The first section 131 represents or comprises the shoring element 16 and is positioned at a distance from and substantially parallel to the third section 133. The second section 132 is substantially perpendicular to the first section 131 and third section 133. The three sections 131, 132, 133 are shaped and arranged to match respective contours of the bracket 8 which substantially comprises an ashlar-formed shape between the recesses 25 and 27.

The retaining element 13 is a one-pieced metal part, in particular it is a one-pieced—in particular bended—sheet-metal part. For example it is made of stainless steel. The retaining element 13 is resilient so that it exhibits a spring like behaviour to counteract an undesired axial movement of the bolt 3. may comprise a slightly flexible behavior to enable a simple arrangement of the bolt 3, for example. The retaining element 13 can be coupled tight or loose to the bracket 8 and at least contacts the bottom surface or an upper surface of the bracket 8, in particular the bottom surface of the first recess 25 and/or the bottom surface of the second recess 27. In the pre-assembled configuration which is illustrated in FIGS. 1, 2, and 3b, the retaining element 13 then gets fastened by the bolt 3 which is arranged through a penetrating opening 15 of the retaining element 13, through the penetrating opening 17 of the bracket 8 already during transport of the assembly 1, before the bolt is inserted into the opening 19 of the cylinder head 11. The bolt 3 prevents or limits lateral displacement of the retaining element 13 relative to the coupling element 5.

Moreover, the retaining element 13 comprises a circumferential sidewall 28 which forms the penetrating opening 15 of the retaining element 13. The circumferential sidewall 28 may comprise one or more fixing protrusions 14 to establish a friction-fit connection with the outer surface of the bolt 3 as the coupling between the bolt 3 and the retaining element 13.

Due to the mechanically interaction between the shoring element 16 of the retaining element 13 and the stopping element 6 of the coupling element 5 and due to the friction-fit coupling of the bolt 3 to the retaining element 13, an elastic counteracting force is generated by the retaining element 13 if an axial movement of the bolt 3 in direction from the second axial end 9 to the first axial end 9 occurs. The elastic force generated by the spring like retaining element 13 then increases as a mechanical force of the bolt 3 generated by an undesirable axial movement increases.

Using such an embodiment of the assembly 1 may enable a coupling of the injector cup to the cylinder head 11 without a necessity for special dimensioning. For example, there is no need for a given thickness of the bracket 8 in order to have a sufficient length as it is required if a plastic retainer is inserted into the penetrating opening 17 of the coupling element 5 to enable a desired elastic or friction force to retain the bolt 3. This is because the retaining element 13 does not extend into the penetrating opening 17 of the bracket 8. For the same reasoning, there is no need for tight geometrical tolerances of the retaining element 13. Moreover, the penetrating opening 15 of the retaining element 13 can match a diameter of the penetrating opening 17 of the bracket 8 to realize a reliable and easy arrangement of the bolt 3.

The locking of the bolt 3 by the retaining element 13 is independent of the thickness of the bracket 8. It is just advantageous that the retaining element 13 adapts the shape of the bracket 8 to enable a bending force acting against a movement of the bolt 3. A design of the retaining element 13 allows for radial clearances for mounting tolerances recovery depending on a respective application. It further allows for larger tolerances of the penetrating opening 17 of the coupling element 5 since the circumferential, in particular cylindrical, surface 18 of the penetrating opening 17 of the coupling element 5 has no function in regards to the retention of the bolt 3 as it would have by using a plastic cylindrical retainer inside the penetrating opening 17, for instances.

The retaining element 13 acts externally against an undesired axial movement of the bolt 3 and beneficially matches a shape of the bracket 8 at least partially. Hence, a reduction of mass and costs of the assembly 1 is possible due to the retaining element 13 externally coupled to the bracket 8.

The retaining element 13 can be made of plastic, metal, rubber or other materials that enable retention of the bolt 3. This also concerns the one or more protrusions 14 at the circumferential surface 28 of the retaining element 13 but in addition a dimensioning, a number and a shape.

FIGS. 4a to 4e show exemplary embodiments of retaining elements 13 configured as one-sided clamps with different shapes and geometries of the protrusions 14 at the circumferential sidewall 28 of the penetrating opening 15.

In FIGS. 4a and 4b there are four protrusions 14 formed in each case at the circumferential surface 28. The protrusions 14 have a half spherical or half cylindrical shape in each case but different diameters. FIGS. 4c and 4d also show embodiments with four protrusions 14 in each case on the circumferential surface 28. However, the protrusions 14 are formed as fixing pins at the circumferential surface 28 in these embodiments, having a substantially rectangular cross-sectional shape but different widths, the width being in particular the dimension perpendicular to the radial dimension of the respective pin.

In contrast, FIG. 4e shows an embodiment with three protrusions 14 with tooth or spike shape. In this embodiment, the protrusions 14 have in particular a triangular cross-sectional shape.

Different numbers, shapes, thickness, geometry and material of the protrusions 14 are possible, depending on given requirements and intended application. Each of the retaining elements 13 is suitable as retaining element 13 of the first embodiment and for other embodiments of the assembly 1.

A further exemplary embodiment of a retaining element 13 is shown in a perspective view in FIG. 5a. FIGS. 5b and 5c show portions of a fuel rail assembly 1 according to a second exemplary embodiment in a perspective view (FIG. 5b) and in a further perspective view in which a portion of the assembly 1 is cut away along a longitudinal plane. The fuel rail assembly 1 of the second embodiment comprises the retaining element 13 according to the embodiment of FIG. 5a.

The fuel rail assembly according to the second exemplary embodiment corresponds in general to that of the first exemplary embodiment. The retaining element 13 corresponds in general to that described above in connection with FIG. 4b. However, the retaining element 13 further comprises a fourth and fifth section 134, 135 respectively and realizes a two-sided clamp.

The third section 133 of the retaining element 13 again comprises the penetrating opening 15 and enables the arrangement of the bolt 3. Two ends of the bottom surface of the bracket 8 acts as stopping elements 6 in mechanical interaction with two shoring elements 16 of the retaining element 13 realized by the first section 131 and fifth section 135 respectively. The first recess 25 which comprises the first axial opening 7 of the penetrating opening 17 of the coupling element 5 extends laterally over the full width of the coupling element 5 to accommodate the third section 133 of the retaining element 13. Two second recesses 27 are provided at opposite lateral ends of the bottom side of the coupling element 5 for accommodating the first section 131 and the fifth section 135, respectively.

The retaining element 13 is attached to the coupling element 5 by means of a snap-fit connection established with the aid of the first and fifth sections 131, 135 and the second recesses 27. In this way, the retaining element 13 is securely attached to the coupling element 5 even when the bolt 3 does not extend through the penetrating openings 15, 17 of the retaining element 13 and the coupling element 15.

1. An assembly for a combustion engine, the assembly comprising:
a coupling element with a penetrating opening having a longitudinal axis,
a retaining element, and
a bolt,
wherein
the bolt extends through the penetrating opening of the coupling element,
the penetrating opening of the coupling element is shaped by a circumferential surface, which circumferential surface extends between a first axial end and a second axial end of the penetrating opening through the coupling element,
a coupling between the retaining element and the bolt is established in a region subsequent to the first axial end in direction from the second axial end to the first axial end, such that an area between the circumferential surface and the bolt is free from the retaining element,
the retaining element and the coupling element configured to interact mechanically to restrict an axial displaceability of the retaining element relative to the coupling element so that the bolt is locked with respect to axial displacement relative to the coupling element by the mechanical interaction of the retaining element and the coupling element and the coupling between the retaining element and the bolt,
the retaining element comprises a first section, a second section adjacent to the first section and a third section adjacent to the second section,
the first axial end of the penetrating opening comprises an upper surface of the coupling element and the second axial end comprises a lower surface of the coupling element, and
the first section is coupled to the lower surface, the third section to the upper surface and the second section to a side surface of the coupling element.

2. The assembly as claimed in claim 1, wherein the retaining element does not extend into a radial gap between the circumferential surface and the bolt.

3. The assembly as claimed in claim 1, wherein the retaining element defines a penetrating opening through which the bolt extends to limit lateral displaceability of the retaining element relative to the coupling element.

4. The assembly as claimed in claim 3, wherein
a circumferential sidewall shapes the penetrating opening of the retaining element, the circumferential sidewall comprises one or more fixing protrusions which extend in radial inward direction and are in friction-fit engagement with the bolt to establish the coupling between the retaining element and the bolt.

5. The assembly as claimed in claim 1, wherein the coupling element comprises a stopping element and the retaining element comprises a shoring element, the coupling element and the retaining element interact mechanically.

6. The assembly as claimed in claim 5, wherein
the coupling element comprises a first recesses and a second recess on opposite sides of the penetrating opening of the coupling element,
the penetrating opening extending from a bottom surface of the first recess which comprises the first axial end to a bottom surface of the second recess which comprises the second axial end, and
the shoring element of the retaining element is arranged in the second recess of the coupling element.

7. The assembly as claimed in claim 5, wherein
the first section comprises the shoring element and is positioned at a distance from and substantially parallel to the third section and the second section is substantially perpendicular to the first and third section respectively, and
the sections are shaped and arranged to match respective contours of the coupling element.

8. The assembly as claimed in claim 7, wherein
the retaining element further comprises a fourth section adjacent to the third section and a fifth section adjacent to the fourth section,
the fifth section is positioned at a distance from and substantially parallel to the third section and the fourth section is substantially perpendicular to the third and fifth section respectively, and
the sections are shaped and arranged to match respective contours of the coupling element.

9. The assembly as claimed in claim 7, wherein
the third section of the retaining element comprises the penetrating opening of the retaining element.

10. The assembly as claimed in claim 1, wherein the assembly is a fuel rail assembly for providing fuel to a fuel injector of the combustion engine and comprises a fuel rail and an injector cup, the injector cup comprising an injector opening for receiving the fuel injector, the fuel rail being fluidly connected to the injector opening.

11. The assembly as claimed in claim 10, wherein the coupling element is comprised by or directly attached to the injector cup.

12. The assembly as claimed in claim 11, wherein
the injector cup comprises a bracket and the bracket is the coupling element.

13. The assembly as claimed in claim 10, further comprising
a separate connecting pipe arranged between the fuel rail and the injector cup, the separate connecting pipe fluidly connects the fuel rail to the injector opening and provides fuel to the fuel injector, wherein the coupling element at least one of comprises and is directly attached to the connecting pipe.

14. The assembly as claimed in claim 10, wherein the coupling element at least one of comprises and is directly attached to the fuel rail.

15. The assembly as claimed in claim 1, further comprising
a cylinder head with an opening, the opening configured for receiving and fixing the bolt to fasten the coupling element to the cylinder head.

16. The assembly as claimed in claim 5, wherein the coupling element comprises and the retaining element interact mechanically through a form-fit connection between the stopping element and the shoring element, to restrict the axial displaceability of the retaining element relative to the coupling element.

17. The assembly as claimed in claim 16, wherein
the coupling element comprises a first recess and a second recess on opposite sides of the penetrating opening of the coupling element,
the penetrating opening extending from a bottom surface of the first recess which comprises the first axial end to a bottom surface of the second recess which comprises the second axial end, and
the shoring element of the retaining element is arranged in the second recess of the coupling element.

18. The assembly as claimed in claim 17, wherein the shoring element of the retaining element is arranged in form-fit engagement with the bottom surface of the second recess.

19. The assembly as claimed in claim 18, wherein
the first section comprises the shoring element and is positioned at a distance from and substantially parallel to the third section and the second section is substantially perpendicular to the first and third section respectively, and
the sections are shaped and arranged to match respective contours of the coupling element.

20. The assembly as claimed in claim 6, wherein the shoring element of the retaining element is arranged in form-fit engagement with the bottom surface of the second recess.
